(19) United States
(12) Patent Application Publication
(10) Pub. No.: US 2013/0076610 A1
(43) Pub. Date: Mar. 28, 2013

(54) ENERGY-SAVING METHOD FOR MARKING AN AREA OF A LIQUID CRYSTAL SCREEN

(71) Applicants: Ivan Dozov, La Bois Persan (FR); Francois Leblanc, Paris (FR); Jean-Denis Laffitte, La Ville Surt Orge (FR); Stephane Joly, Saint Saturnin (FR); Philippe Martinot-Lagarde, Marcoussis (FR); Jacques Angele, Malakoff (FR)

(72) Inventors: Ivan Dozov, La Bois Persan (FR); Francois Leblanc, Paris (FR); Jean-Denis Laffitte, La Ville Surt Orge (FR); Stephane Joly, Saint Saturnin (FR); Philippe Martinot-Lagarde, Marcoussis (FR); Jacques Angele, Malakoff (FR)

(73) Assignee: NEMOPTIC S.A., Magny les Hameaux (FR)

(21) Appl. No.: 13/698,987

(22) PCT Filed: Oct. 8, 2009
(86) PCT No.: PCT/FR2009/001190

§ 371 Date: Nov. 19, 2012

(30) Foreign Application Priority Data
Oct. 15, 2008 (FR) 08290975.5

(51) Int. Cl. G09G 3/36

(52) U.S. Cl. CPC G09G 3/3611
USPC 345/90

(57) ABSTRACT

The present invention relates to a method of addressing a bistable matrix screen, in which the following two steps are reiterated:

A. a disturbance signal is applied to each pixel of a marking area for a time t1, said disturbance signal being higher than a threshold signal such that each pixel of the area leaves its initial stable state, said disturbance signal being lower than a switching signal such that each pixel of the area having one of the stable states as its initial state does not switch into the other stable state, each pixel of the area then being in an intermediate disturbed state that is intermediate between the two stable states, and then

B. no signal is applied to each pixel of the area for a time t2 to allow each pixel of the area to return to its initial stable state.

### FIELD OF THE INVENTION

The invention relates to a method of addressing a liquid crystal display screen and a display device implementing this method.

More precisely, the present invention relates to bistable liquid crystal displays. It applies in particular to bistable nematic liquid crystal displays whose two stable textures differ by a twist of approximately 180°.

### STATE OF THE ART

The most widely-used liquid crystal displays use a nematic-type liquid crystal. They are constituted by a layer of liquid crystal placed between two plates. Each plate comprises a substrate, frequently made of glass, on which a conductive electrode and then a so-called anchoring layer, also called an alignment layer, have been deposited. The anchoring layer exerts on the neighbouring liquid crystal molecules a return torque, which tends to orient them parallel to a direction termed the easy axis. The anchoring layers are preferably produced by a deposit of brushed polymer for creating the direction of the easy axis. This direction of the easy axis is preferably very close to the direction of brushing.

The thickness of the cell thus constituted, referenced d, is rendered constant for example by distributing, between the plates, balls the diameter of which is equal to the desired thickness (typically from 1 to 6 μm).

Devices based on monostable liquid crystals are known. In the absence of an electric field, the liquid crystal is oriented according to a single texture. This texture corresponds to an absolute minimum of the elastic energy of the liquid crystal in the cell, taking account of the anchorings on the two plates. Under an electric field, this texture is continuously deformed and its optical properties vary as a function of the voltage applied. Anchoring layers called “strong anchoring layers” maintain the direction of the molecules situated close to the plates, which vary little, both in the plane of the substrate (azimuthal plane) and in the direction perpendicular to it (zenithal direction): a strong anchoring of the molecules close to the plates on the alignment layer corresponds to a strong azimuthal anchoring (maintaining a fixed direction in the plane of the substrate) and a strong zenithal anchoring (maintaining a direction close to the plane of the substrate, i.e. little or no raising of the molecules towards the direction perpendicular to the substrate, parallel with the electric field, and this being so whatever the voltage applied).

When the field is turned off, the nematic liquid crystal is returned by the anchorings on the two plates. It returns according to the single stable texture without an applied field. The device is monostable. A person skilled in the art will recognise the mode of operation of the most widespread nematic displays: twisted nematic (TN), super-twisted nematic (STN), electrically controlled birefringence nematic (ECB), vertical aligned nematic (VAN), etc. At the addressing level, these displays can be addressed directly (very low resolution), in passive multiplexed mode (average resolution) or in active mode (high resolution). When the addressing is multiplexed, i.e. carried out row by row, in order that the image may appear visually stable, the addressing signals must be sent at a frequency of several tens of hertz: as soon as the pixel is no longer under voltage, it relaxes into the stable state with no applied field.

It is possible to obtain a blinking effect on these monostable displays, for example in a given area of the display, called the blinking area. This area can be the whole of the addressed surface of the display or part of it. The blinking corresponds here to obtaining in said area an image which appears, then disappears, then reappears and so on, the disappearance of the image being characterized by a uniform tint over the whole of said area. A uniform tint is a tint that is substantially identical for all of the pixels of the area, the colour of the tint being able to be any colour. In order to obtain this blinking effect, it is necessary to address said area of the display by sending it:

the signals corresponding to the image to be displayed in order to make the image appear

the signals corresponding to a uniform tint over the display

again the signals corresponding to the image to be displayed in order to make the image reappear.

Monostable displays do not have image memory, once the signals corresponding to the uniform tint have been applied, the display “forgets” the previously applied image and it is necessary to again send the signals corresponding to said image in order to display it again.

### PURPOSE OF THE INVENTION

The purpose of the present invention is to improve the performance of liquid crystal display devices. In particular the purpose of the invention is to allow, by the use of novel means, the marking of a part or of the whole of the information displayed on a liquid crystal display, whilst maintaining a reduced energy consumption in comparison with that of a standard liquid crystal display.

### DESCRIPTION OF THE INVENTION

This objective is achieved with a method of addressing a matrix screen, said screen comprising:

a layer of bistable liquid crystal divided into pixels of bistable liquid crystal and,

for each pixel, means of applying a signal to this pixel, the applied signal comprising an electric field,

each pixel of bistable liquid crystal having two possible stable states which are stable without an electric field being applied to this pixel, the two stable states corresponding to different visual perceptions for an observer observing the screen, said method being characterized in that it comprises the following steps:

A. a signal called a disturbance signal (Sp) is applied to each pixel of an area of pixels which are in an initial state corresponding to one of the stable states, and for a given first period of time (t1), said disturbance signal being higher than a threshold signal such that each pixel of the area leaves its initial state, said disturbance signal being lower than a switching signal such that each pixel of the area having one of the stable states as its initial state does not switch into the other stable state, each pixel of the area then being in a disturbed intermediate state that is intermediate between the two stable states, and then

B. no signal is applied to each pixel of the area for a second given period of time (t2) in order to allow each pixel to return of the area to its initial stable state, and then

C. the preceding two steps A and B are reiterated.

In a variant, the steps A and B are reiterated preferably a number of times greater than 1, in order to obtain a visual effect of blinking of the area caused by an alternation of the disturbed state and the initial state for each pixel of the area.

In another variant, two successive iterations of steps A and B are preferably spaced apart by a duration less than a duration of retinal persistence of the observer, in order to obtain a visual effect of static marking of the area.

The method according to the invention can comprise moreover a displacement of the area of pixels over the screen between at least two iterations of steps A and B.

The pixels of the layer are preferably arranged in parallel rows of pixels and in parallel columns of pixels, the rows being substantially perpendicular to the columns. The disturbance signal applied to a pixel preferably comprises a column signal applied to the column on which that pixel is situated and moreover preferably comprises a row signal applied to the row on which that pixel is situated, this disturbance signal preferably being proportional or equal to a difference between the column signal and the row signal. In a variant, the area can comprise a set of adjacent rows or a set of adjacent columns. In another variant, the area can comprise an intersection of a set of adjacent rows and a set of adjacent columns.

The disturbance signal can be:

an erase signal for which the disturbed state of a pixel initially in one of the stable states is identical to the disturbed state of another pixel initially in the other stable state, the disturbed states of two pixels initially in two different stable states corresponding to a same visual perception for the observer observing the screen, or

an intermediate disturbance signal for which the disturbed state of a pixel initially in one of the stable states is different from the disturbed state of another pixel initially in the other stable state, the disturbed states of two pixels initially in two different stable states corresponding to different visual perceptions for the observer observing the screen.

The disturbance signal can comprise:

a constant-voltage electric signal, or

a periodic signal; in this case, the frequency of the disturbance signal can be comprised between 50 Hz and 500 Hz, or can be higher than 500 Hz.

The two stable states preferably comprise a blocking state and a passing state, the passing state having a luminance (Lib) perceived by the observer as higher than the luminance (Lid) of the blocking state, the disturbed state of a pixel initially in the passing state having a luminance (Lpb) perceived by the observer as lower by at least 5% with respect to the luminance (Lib) of the initial passing state of this pixel.

The disturbance signal can comprise an electric signal having an effective RMS voltage value greater than 1.65 times a Freedericksz voltage of the liquid crystal layer.

Finally, the disturbance signal is preferably bipolar.

### BRIEF DESCRIPTION OF THE FIGURES

The different objects and characteristics of the invention will become more clearly apparent in the following description and in the attached figures in which:

FIG. 1 is a diagrammatic presentation of a part of a first embodiment of a device according to the invention comprising a bistable display of the ZBD type and implementing a method according to the invention,

FIG. 2 is a diagrammatic presentation of a part of a second embodiment of a device according to the invention comprising a bistable display of the BiNem type and implementing a method according to the invention,

FIG. 3 describes the structure of a matrix screen with passive multiplexed addressing of the first or of the second embodiment of the invention,

FIG. 4 describes an example of passive addressing in two steps of the screen of the second embodiment of a device of the BiNem type according to the invention,

FIG. 5 shows variations of the luminance of pixels as a function of the RMS voltage of a disturbance signal Sp of frequency 600 Hz applied during the implementation of a method according to the invention,

FIG. 6 illustrates an example of embodiment of the method according to the invention on a bistable display where a set of columns (marking area) is marked; FIG. 6a shows the display in the rest state with an image previously displayed on the marking area; FIG. 6b shows the display when an “intermediate” disturbance signal is applied over a portion of the columns, the initial textures still being distinguished, the dimming of the image of the marking area being partial, the contrast of this image being degraded but its content still is readable; FIG. 6c shows the display when an “erase” disturbance signal is applied, the dimming of the image in the marked area being total.

FIG. 7 illustrates examples of signals applied during the implementation of a method according to the invention, the row signal being connected to earth, the column signal VC being monopolar (positive or negative) and having a pulse shape of amplitude Vblink,

FIG. 8 illustrates another example of signals applied during the implementation of a method according to the invention, the row signal being equal to a mean potential Vm and the column signal being constituted by an alternation between Vm+Vblink and Vm−Vblink.

FIG. 9 illustrates an example of applying, according to the invention, disturbance voltages on the rows and columns in order to strongly deforming solely the textures of a rectangular field.

FIG. 10 is another example of applying, according to the invention, disturbance voltages on the rows and columns in order to deform the textures of the rectangular field to a lesser degree than in the case of FIG. 9 but saving much energy.

### DETAILED DESCRIPTION OF THE INVENTION

### Device Implementing the Method According to the Invention

A first and a second embodiment of a device according to the invention (also called a display) implementing a method according to the invention will now be described.

These embodiments comprise a matrix screen making it possible to display an image, said screen comprising:

a layer of bistable liquid crystal molecules divided into pixels of bistable liquid crystal and,

for each pixel, means of applying a signal to this pixel, the applied signal comprising an electric field, these means of application being in particular arranged to apply a disturbance signal Sp according to the invention in an iterative manner according to the method according to the invention described hereafter.

Each pixel of bistable liquid crystal has two possible stable states. These two stable states are stable without an electric field being applied to this pixel, the two stable states corresponding to different visual perceptions for an observer observing the matrix screen.

Each stable state of a pixel corresponds to a given stable texture of molecules of liquid crystal at the level of this pixel.

The pixels are arranged in parallel rows of pixels and in parallel columns of pixels, the rows being substantially perpendicular to the columns.

The liquid crystal of the layer is of the nematic type. The layer of liquid crystal is placed between two plates, the assembly constituting a liquid crystal cell. Each plate comprises a substrate, preferably made of glass, on which a conductive electrode and then a so-called anchoring layer, also called an alignment layer have been deposited. The anchoring layer exerts a return torque on the neighbouring liquid crystal molecules, which tends to orient them parallel to a direction termed the easy axis. The anchoring layers are preferably produced by a deposit of brushed polymer for creating the direction of the easy axis. This direction of the easy axis is preferably very close to the direction of brushing.

The thickness of the cell thus constituted (i.e. the distance between the plates between which the layer of liquid crystal is comprised), referenced d, is rendered constant for example by distributing, between the plates, balls the diameter of which is equal to the desired thickness (typically from 1 to 6 μm).

The liquid crystal of the layer is “bistable”: this type of liquid crystal functions by switching between two stable states in the absence of electric field. An external electric field is applied only for the time necessary in order to make the texture of the liquid crystal switch from one state to the other. In the absence of an electric control signal, the display remains in the state obtained. Due to its operating principle, this type of display consumes energy proportional to the number of changes of image. Thus, as the frequency of these changes reduces, the power necessary for the operation of the display tends towards zero.

### ZBD Technology and BiNem Technology

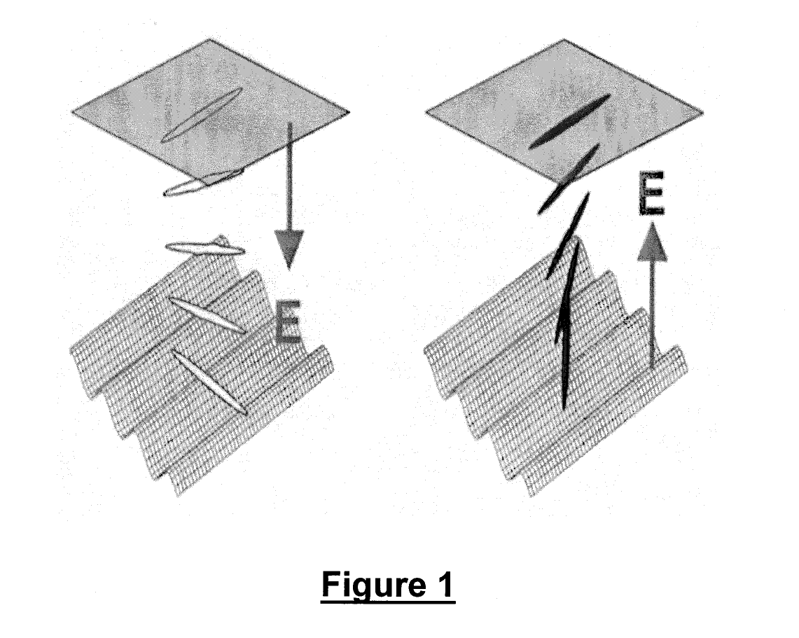

FIG. 1 illustrates, for the first embodiment of a device according to the invention, two different states of a pixel of liquid crystal between two portions of the plates. This first embodiment uses a flexoelectric effect for switching, i.e. the sign of the electric field applied. It is the pretilt, i.e. the angle that the molecule of liquid crystal close to the surface forms with the latter, which varies between two stable values without an applied field. This bistability is obtained using a grating serving as an alignment layer (cf documents [1], [2], [3] and FIG. 1). This technology is called ZBD (Zenithal Bistable Display). One of the alignment layers is constituted by a periodic grating allowing, in the vicinity of the surface of this grating, two orientations of the molecules of liquid crystal, one of them planar and the other one homotropic.

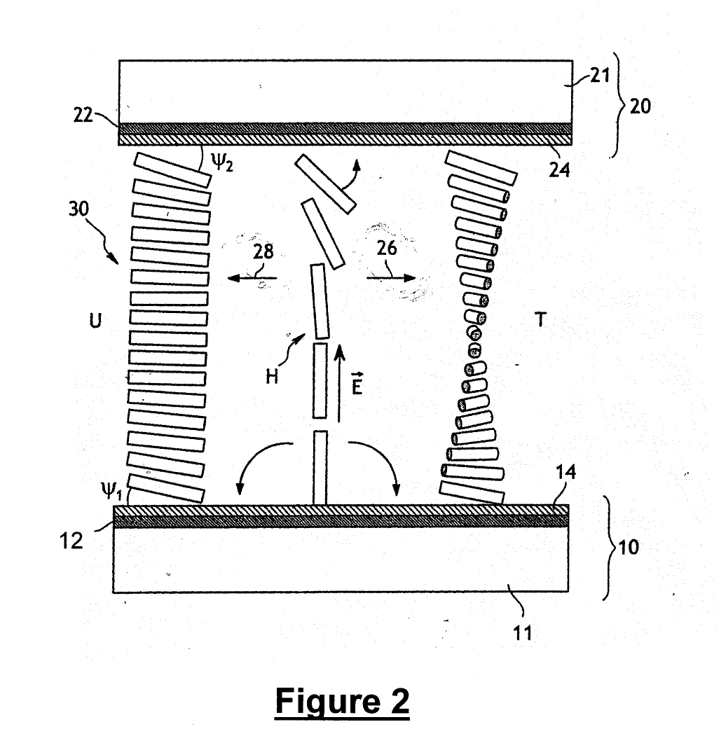

FIG. 2 is a cross-sectional and profile view of a portion of the liquid crystal cell of the second embodiment of a device according to the invention. In this figure, three adjacent liquid crystal pixels are shown. This second bistable embodiment uses a surface effect: a break in the zenithal anchoring over at least one of the alignment layers. This break allows the switching between two textures the twists of which differ by an angle of between 150° and 180° in absolute value. The operation of this display, called a BiNem display, is described in the following paragraph.

The BiNem display (documents [4] to [8]) is shown diagrammatically in FIG. 2, and has a general configuration identical to that of the liquid crystal cell of ZBD type which also uses substrates, electrodes, polarizers and liquid crystal. The BiNem display preferentially uses two twisted textures which differ by a twist of approximately +/−180°, (situated in absolute value between 150° and 180°). A preferred but non-limitative variant is constituted by a uniform or weakly twisted texture denoted U (illustrated on the left of FIG. 2) in which the molecules are substantially parallel to each other, and by a strongly twisted texture denoted T (illustrated on the right of FIG. 2). The least twisted texture U has a twist of between 0° and 20° in absolute value. The layer of liquid crystal 30 is placed between the two plates 20 and 10, which are respectively called the master plate and the slave plate. The master plate 20 comprises a substrate 21, an electrode 22 and an anchoring layer 24 producing a strong azimuthal and zenithal anchoring of the liquid crystal, i.e. an anchorage of the same type as that used in monostable liquid crystal displays. The slave plate 10 comprises a substrate 11, an electrode 12 and an anchoring layer 14 producing a specific anchoring, corresponding to a weak zenithal anchoring and an average or strong azimuthal anchoring of the liquid crystal. The electrodes 12 and 22, usually transparent, are typically constituted by a material called ITO deposited on the substrates 11 and 21. They make it possible to apply an electric field perpendicular to the plates 10 and 20.

The addition of polarizers on each of the substrates 11 and 21 typically but not limitatively on the outside of the cell makes it possible to associate each texture with an optical state, for example dark for the texture U and light for the texture T or vice-versa, according to the angles of the two polarizers with respect to the anchoring directions.

Depending on the type of rear polarizer, i.e. situated on the other side of the layer of liquid crystal with respect to the observer of the display, it is possible to obtain various optical modes: transmissive, transflective or reflective (documents [9], [10]). A configuration using a single polarizer on the observer side and a diffusing mirror on the opposite side is also possible ([18], [19]).

The nematic is chiralized with a spontaneous pitch po, chosen close to four times the thickness d of the cell, in order to equalize the energies of the two textures mentioned previously. The ratio between the thickness d of the cell and the spontaneous pitch po, i.e. d/po, is therefore approximately equal to 0.25+/−0.1. With no field, the states T and U are the minimal energy states: the cell is bistable.

Under a strong electric field, an almost homotropic texture, denoted H and illustrated in the centre of FIG. 2, is obtained. In the vicinity of the surface of the slave plate 10, the molecules are perpendicular thereto, the zenithal anchoring is said to be “broken”. This break is obtained due to the weak zenithal anchoring property on this plate, which allows the molecules close to the surface to escape the attraction of the alignment layer in the direction perpendicular to the substrate. The voltage, Vcass, corresponding to the breaking of the anchoring on the slave plate 10 is called the break voltage. In fact it is to the breaking electric field, Ecass=Vcass/d, that the molecules are sensitive. Typically Ecass is less than 15V/μm at ambient temperature (25° C.) for the alignment layers with weak zenithal anchoring such as described in the documents [11] and [12]. The breaking voltages are then:

for d=1 μm Vcass<15V; for d=2μm Vcass<30V; for d=5 μm Vcass<75V.
Moreover, the breaking voltage Vcass is always at least a few volts, and this is so even for very thin (1 μm) liquid crystal cells.

When the electric field is turned off, the cell changes to one or other of the bistable textures U and T (see FIG. 2). When the control signals used induce a strong flow of the liquid crystal in the vicinity of the master plate 20, the hydrodynamic coupling 26 between the master plate 20 and the slave plate 10 creates a hydrodynamic flow (or flux) close to the slave plate sufficient to induce the texture T. In the opposite case, the texture U is obtained by elastic coupling 28 between the two plates 10 and 20, helped by the possible tilt of the weak anchoring.

Hereafter, by “switching” of a screen element or pixel of a BiNem type display is meant the fact of changing the liquid crystal molecules from an initial stable texture (U or T or a coexistence of these two textures) to a final stable texture (U or T or a coexistence of these textures). This term is also valid for the two stable textures of the ZBD type display.

The signal applied to the pixel is in a standard fashion constituted by several plateaux. The signal applied to the pixel VP is in a standard fashion a two-plateau signal, but can be also multi-plateau [13] or single-plateau. If the voltage drop between two plateaux exceeds a certain absolute value, and if it operates over a sufficiently short time, the voltage “jump” is sufficient for the texture T to be obtained. If the jump is not sufficient, or if the transition time is too long, the hydrodynamic flow is insufficient, texture T becomes impossible, and texture U is obtained.

### Addressing Modes

The three addressing modes developed for standard liquid crystals (direct, passive multiplexed, active) can be used for the BiNem or ZBD display. The most common addressing mode is passive multiplexed addressing, but an active addressing using transistors in thin films is also possible [14]. In the multiplexed active and passive modes, the display (of Binem or ZBD type) is a matrix screen formed of N×M screen elements called pixels, N being the number of rows of pixels and M the number of columns of pixels, and the addressing is carried out row by row.

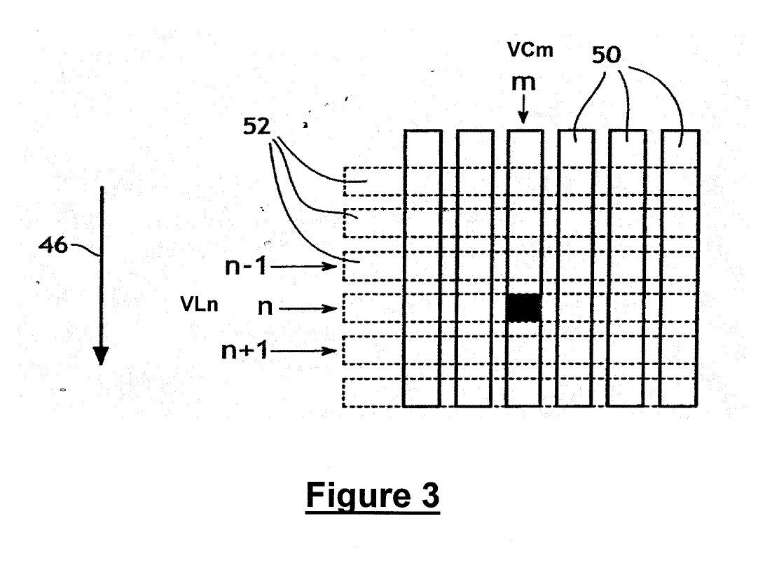

In the passive multiplexed mode, such as illustrated in FIG. 3, each pixel is constituted by the intersection:

of a row conductive electrode or band 52 deposited on one of the plates and corresponding to a row of pixels, and

of a column conductive electrode or band 50 deposited on the other plate and corresponding to a column of pixels.

These perpendicular bands 50, 52 are deposited on each plate. The area situated between two adjacent conductive bands carried by a same substrate is called the inter-pixel space.

The area constituted by the pixels as a whole is called the matrix area. A marking area Zm is a part of this matrix area. Customarily in the state of the art, the matrix area corresponds to the display area, the area on which is displayed the content of the image that it is desired to display . Outside of the matrix area, the aforesaid conductive bands 50, 52 transform into tracks providing the connection to the control circuits generating the addressing signal.

These control circuits can be situated on the substrate or offset. In a standard fashion but non-limitatively, the displays are addressed using control circuits or components that we will call “drivers” situated for example on flexible connection elements soldered to the screen. The drivers, constituted principally by analogue gates controlled by shift registers, enable the link to be made between the control electronics and the tracks.

In order to display the pixel P of coordinates (n, m), n being the number (integer) of the row on which this pixel is situated, m being the number (integer) of the column on which this pixel is situated, a row addressing signal VLn is applied on row n and a column addressing signal VCm is applied on column m. Generally, the conductive electrodes are produced from a transparent conductive material called ITO (indium tin mixed oxide). But when the display is reflective, the electrodes situated on the opposite side to the observer can be produced with an opaque conductive material, for example aluminum.

One of the important differences to note between the passive mode and the active mode is that in the passive multiplexed mode, the voltage is applied via strips of orthogonal electrodes constituting the rows and the columns, the intersections of which constitute the pixels, while during active addressing the voltage is applied via fine wires to the transistors associated with each pixel. All the transistors of a same row are conducting during the activation of this row.

### Control of a BiNem Display in Multiplexed Mode

When the structure of the display is matrix-type as described previously, addressing is carried out row by row. When it is desired to write to a given row n, an electric signal is applied to this row, which is then said to be “activated”. We will call this row addressing signal, the row activation signal VLn. In the case of a standard passive multiplexing, the signal VLn is identical for all the rows, and we will call it VL.

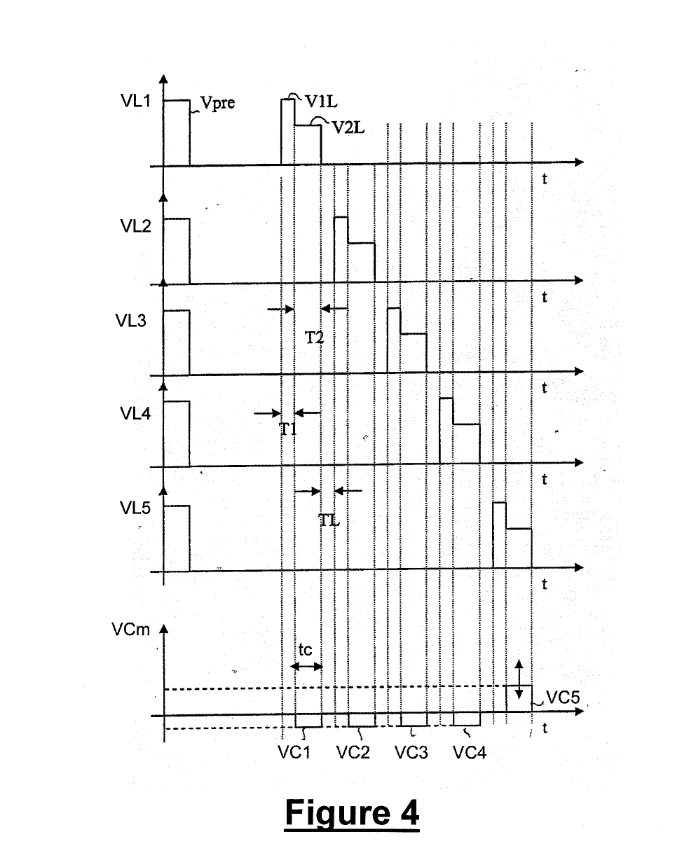

For BiNem, with reference to FIG. 4, two phases are distinguished during activation: the first phase consists essentially of obtaining an anchoring breaking, i.e. the homeotropic texture on the row in question, by applying for example a voltage V1L>Vcass to the row addressing signal for a duration T1, which constitutes a first VL plateau. Typically in the current technologic state for BiNem, V1L is comprised between 6V and 30V over the temperature range 0°−50°. During the second phase, a signal V2L is applied to the row for a duration T2, which constitutes a second and last VL plateau. Typically in the current technologic state for BiNem, V2L is comprised between 2V and 12V over the temperature range 0°−50°. The row addressing signal is in this example two-plateau, but it can also be single-plateau or multi-plateau. A variant uses a row signal lower than the break voltage, the column signal allowing the switching into one or other of the textures [20]; or, according to a variant with two steps, all the pixels are first switched into a same texture and then the column voltage causes the break but only in the pixels to be switched into the other texture.

Electrical signals known as “data” called VC are applied simultaneously on all the columns. According to a standard variant, the trailing edge of signal data VC is synchronised with the trailing edge of the second plateau of row activation signal V2L [4].

Depending on the value of the voltage and/or its' form and/or the duration tc of the signal VCm applied simultaneously to each of the columns, texture U or T is obtained in the pixel corresponding to the intersection of this column and the activated row. Then the following row is activated in turn, the other rows being non-activated and so on, from the first to the last row of the display. The time between the end of activation of a row and the start of activation of the following row is called inter-row time TL. This time is typically but non-limitatively comprised between 10 μs and 10 ms. We will call this addressing “one-step addressing”. The order of activation of the rows (first n−1, then n, then n+1) defines the direction of sweep 46 (see FIG. 3). The addressing time of the display is the time necessary for addressing all its rows, in such a way as to display a new image content.

Document [15] describing the production of grey levels provides three variants for obtaining grey levels (FIG. 23 of document [15]) by modifying the VC parameters.

According to a method of use called partial addressing, it is desired to display new content in only one area of the image, the remainder of the image remaining unchanged. In this case, only the rows corresponding to the area where it is desired to display a new content are activated.

According to a preferred known, but non-limitative, control method, prior to the row-by-row addressing, the full addressing of the screen (display of a whole image), or of an area of the screen (partial addressing) is carried out collectively in a given texture, usually T, by simultaneously activating all the rows or a group of rows corresponding to the area to be addressed, with a signal Vpre. The rows are then addressed one by one, according to the standard multiplexing method, in order to display the desired image or area. Thus only two transitions have to be carried out, the transition T to T on the one hand, and the transition T to U or to a mixture of U and T on the other hand. This “two-step addressing” allows better management of pixel switching, as in this way the pixels all start from a well-defined state at the beginning of the second step. According to the variant where the row voltage is lower than the break voltage, during the second step the column voltage causes the break only for the pixels whose state (texture) one wishes to modify. By way of example, the principle of multiplexed passive addressing of the Binem display in two steps is illustrated in FIG. 4. The column-addressing signal applied to the column m is chosen here such that tc=T2. The values VC1 to VC5 are the values of VCm applied on the column m synchronized with the successively activated rows 1 to 5, in order to obtain the desired final texture on the pixel at the intersection of the activated row and the column m. In a mode where it is sought to obtain only either U or T, it is possible to choose for example a voltage VC in pulse form and different variants are possible:

VC(U)=+Vcol and VC(T)=−Vcol (example of FIG. 4)
VC(U) is the column addressing signal for obtaining the texture U.
VC(T) is the column addressing signal for obtaining the texture T.
or: VC(U)=+Vcol and VC(T)=0, or vice-versa.

According to a preferred known but non-limitative embodiment of a BiNem display, the brushing direction of the alignment layers is orthogonal to the direction of the rows of the display, this type of display is known as having “orthogonal brushing” (document [15]).

In order to avoid electrochemical effects in the liquid crystal, bipolar pulses can be used for the signal Vpre and for the signal VL.

### Threshold Voltage V0 and Freedericksz Voltage VF

In liquid crystal cells, it is noted that the field to be applied, in order to orient the molecules, most often has a threshold. For example, consider a nematic of positive dielectric anisotropy placed in a cell with planar and parallel anchoring on the two plates; without a field, the molecules are parallel with each other and parallel with the plates in the assembly of the cell. An electric field, applied perpendicularly to the plates, begins to orient the molecules only when the voltage is higher than a certain threshold, called the

Freedericksz threshold VF or the Freedericksz voltage VF (document [16]). Below VF, the molecules of liquid crystal remain immobile, held by the nematic elasticity. Starting from VF, as the voltage increases, the molecules of liquid crystal turn progressively in the direction of the field: firstly those situated in the centre of the cell and then the others, except for those close to the plates, whose alignment is maintained by the anchoring.

The voltage VF can be expressed by the following formula:

VF=π[K11/|Δε|)]^{1/2}

where K11 is one of the elastic constants of the liquid crystal and Δε is its dielectric anisotropy. According to the sign of AE, the molecules tend to orient parallel with (Δε>0) or perpendicular (Δε<0) to the applied field. VF is independent of the thickness of the liquid crystal cell and typically varies, for the liquid crystal mixtures used in displays, between 0.3V and 1V.

As Δε is a function of the frequency of the signal applied to the liquid crystal:

VF(static) or VFs refers to the Freedericksz voltage corresponding to a signal applied continuously (i.e. with a zero frequency), and

VF(dynamic) or VFd refers to the Freedericksz voltage corresponding to an applied signal having a frequency higher than the response frequency of the liquid crystal.

Typically VFd is slightly higher than VFs.

When the tilt of the molecules on a plate (pretilt) is high, the threshold disappears. For intermediate pretilts, typically a few degrees, the threshold remains but it is less marked. When the cells are twisted or doped, but still planar, the threshold remains but the threshold voltage can vary up to approximately 30% with respect to the theoretical voltage VF obtained with a cell with planar and parallel anchoring. Thus, for textures of liquid crystal different from that used for measuring the Freedericksz threshold, threshold effect is referred to, characterized by a threshold voltage, called V0, the value of which always remains relatively close to VF.

The presence of this threshold effect imposes a minimum value on the control signals of nematic displays, this is one of their assets. It makes it possible to prevent the displayed images from being disturbed by interference signals; it suffices that these interference signals have an amplitude less than the threshold voltage. This property is fundamental for multiplexing.

### Disturbance Signal Sp Applied According to the Invention.

The invention makes it possible to mark a pixel or an area of a bistable matrix display comprising two stable liquid crystal textures with no applied field, by an original method, which is not applicable to monostable displays. The marking concept is defined by a visually detectable optical modification of this area with respect to the rest of the image. The disturbance signal Sp does not modify the information contained in the image previously displayed in the marking area Zm.

The inventors have shown that it was possible to produce this additional function on these bistable displays without switching any of the pixels of the screen and therefore both rapidly and with a minimal expenditure of energy.

An image is previously displayed on the screen by switching each pixel into one of said initial stable states.

The method according to the invention implemented by the bistable liquid crystal display comprises the following steps:

a) a signal called a disturbance signal Sp is applied to each pixel of an area Zm of pixels that are in an initial state corresponding to one of the stable states, and for a given first period of time t1, said disturbance signal being higher than the threshold signal V0 such that each pixel of the area leaves its initial state, said disturbance signal being lower than the switching signal Vcass, such that each pixel of the area having one of the stable states as its initial state does not switch into the other stable state, each pixel of the area then being in an intermediate disturbed state between the two stable states; thus, a visual disturbance of the image previously displayed in the area Zm is generated for said first time period t1; then

b) no signal is applied to each pixel of the area for a second given period of time t2 to allow each pixel of the area to return to its initial stable state, then

c) the two preceding steps a) and b) are reiterated a number of times greater than one and at a reiteration frequency equal to t1+t2.

Thus, the proposed method is to apply, over the whole of a marking area Zm comprising a set of pixels to be marked, for the time period t1, an electric signal called a disturbance signal Sp having a defined amplitude not comprising any continuously zero ranges, then not applying any signal for the time period t2.

The electric disturbance signal Sp applied, by the means of application, to a pixel comprises:

an electric column signal applied to the column on which this pixel is situated, such as a column addressing signal VC or VCm addressed as described previously, and

an electric row signal applied to the row on which this pixel is situated, such as a row addressing signal VL or VLn addressed as described previously, this disturbance signal Sp being proportional or even equal to a difference between the column signal and the row signal:

Sp=VL−VC

or

Sp of the pixel (n, m)=VLn−VCm

The amplitude of the disturbance signal Sp is:

higher than the Freedericksz threshold VF and than the threshold voltage V0, and

clearly below the switching thresholds and the breaking voltage Vcass.

This signal, called the disturbance signal Sp, deforms the two textures corresponding to the two states of the pixels: their optical properties are modified, the contrast reduces to the value of the disturbance signal for which the area assumes a uniform tint.

The disturbance signal Sp is not intended to modify each pixel of the area Zm independently. There is no individual modification of the pixels of the area Zm, for example in order to display a new image with grey levels comprising new information.

The disturbance signal Sp modifies uniformly, i.e. in an identical fashion, all the pixels of the area which are in a given initial state, said initial state being one of the two possible stable states without an applied field: all the pixels initially in the stable passing state have the same disturbed luminescence Lpb, and all the pixels initially in the stable blocking state have the same disturbed luminescence Lpd. The modification of the optical state of the pixels, carried out by the disturbance signal, is the same for all the pixels initially in the same stable state. For each initial stable state, whatever pixel is in this state, the disturbed state is identical. There are thus two disturbed states in the case of an intermediate erase signal, and a single disturbed state in the case of an erase disturbance signal.

The disturbance signal Sp is identical for all the pixels of the area Zm, whatever their initial stable state. The disturbance signal is identical for all of the pixels of the marking area Zm, in order to obtain a homogeneous disturbance over all of the area.

The disturbance signal, whether an erase or intermediate signal, does not modify, in the area, the information contained in the image previously displayed.

However, as the disturbance signal is clearly lower than the switching thresholds, the orientation of the molecules close to the plates practically does not change during t1: the screen stores the initial image on the plates. It suffices to stop the disturbance signal for each of the pixels to return to their equilibrium texture without a field. The image preceding the deformation is thus reconstituted at the beginning of t2 in a few milliseconds with no expenditure of energy. During the disturbance no additional information was displayed, since the optical effect of the disturbance signal is the same for all the pixels initially in the same stable state, and the reconstituted image when the disturbance signal is stopped is the previously-displayed initial image.

The marking of the screen area is thus produced by the disappearance, for t1, and then the reappearance, for t2, of the image in this area.

The typical duration t1 is between 0.1 and a few tens of seconds, and the typical duration of t2 is comprised between 0.1 s and a few minutes, such that the typical duration of t1+t2 is between 0.2 s and a few minutes.

### Effect of the Disturbance Signal Sp: Modification of the Luminance

In the particular case of a BiNem display, these two stable states correspondent to the textures U and T.
In general, the two stable states include:
a bright state, also called the passing state and
a dark state, also called the blocking state.

Let Lib be the luminance (expressed in candelas/m²) originating from a pixel whose texture corresponds to the so-called bright or passing state of this pixel, and let Lid be the luminance (expressed in candelas/m²) coming from a pixel the texture of which corresponds to the dark or blocking state of this pixel. In order to define the luminances emitted by the display, the luminances measured in the direction perpendicular to the substrates will be chosen. When the display is in reflective mode, the measurement of luminance depends on the type of lighting illuminating the cell. In order to characterize the luminance of the display in reflective mode diffused lighting will be chosen, and the luminance reflected through the display in the direction perpendicular to the substrate is collected and blocking the area around the detector, in order not to collect in the detector rays originating from the specular reflection of the lighting source on the front face (air/display interface) of the display (known as the “specular excluded” method). This method of measuring the luminance of the display in reflective mode using diffused lighting, called “specular excluded”, is described in document [17]. It makes it possible to obtain a measurement of contrast (ratio between the luminance of the passing state and the luminance of the blocking state) and a measurement of reflectance (ratio between the luminance of the display in the passing state and the luminance obtained on replacing the display by a diffuser of the Lambertian type). The reflectance is expressed as a percentage (%).

The passing state has a luminance Lib perceived by the observer greater than the luminance Lid of the blocking state.

The disturbance signal Sp applied to the marking area for a time period of t1 has the effect of orienting the molecules of liquid crystal in the volume as a function of this applied signal Sp and therefore differently with respect to their initial orientation with no applied field. This new orientation causes a modification of the luminance originating from each pixel of the display. The marking zone Zm comprises at least one, even several pixels which are initially in the passing state before application of the disturbance signal, and comprises moreover at least one, even several pixels which are initially in the blocking state before application of the disturbance signal.

The following notations are used;

Lpb for the luminance (expressed in candelas/m²) originating from a pixel which is in an intermediate disturbed state that is intermediate between the two stable states because of the application of a disturbance signal, this pixel initially being in the passing state before the application of the disturbance signal, and

Lpd for the luminance (expressed in candelas/m²) originating from a pixel which is in an intermediate disturbed state that is intermediate between the two stable states because of the application of a disturbance signal, this pixel initially being in the blocking state before the application of the disturbance signal.

Thus, Lpb and Lpd are the luminances of the disturbed pixels having initial stable states corresponding to the luminances Lib and Lid respectively. As the disturbance signal Sp does not display any additional information, for a given disturbance signal, the obtained luminance Lpb is identical for all the pixels initially in the passing state and the obtained luminance Lpd is identical for all the pixels initially in the blocking state.

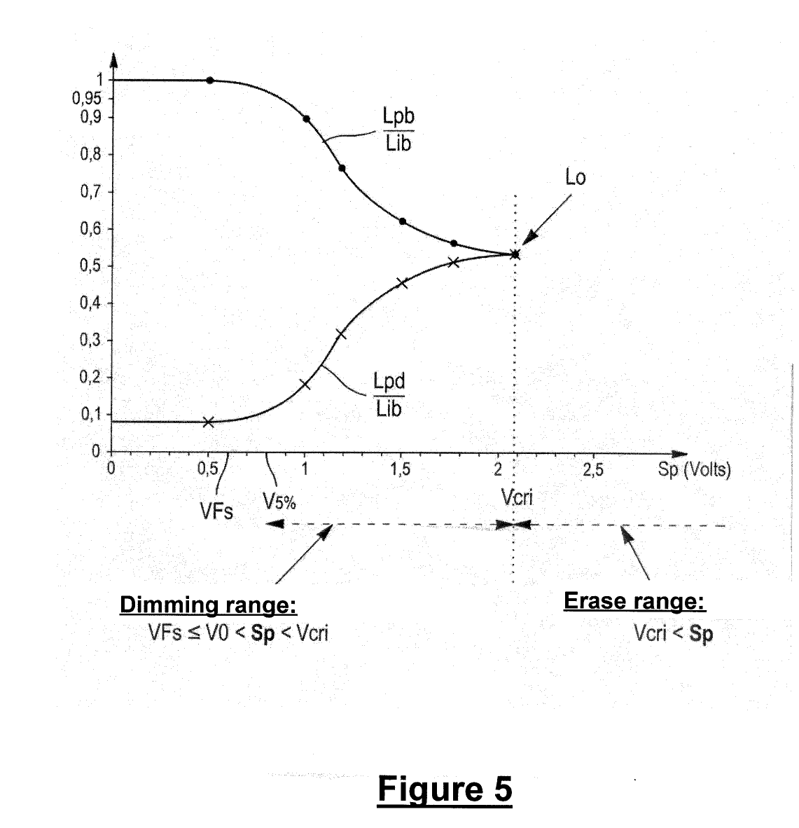

An RMS (Root Mean Square) voltage is also called the effective value of this voltage. FIG. 5 shows the variation of the ratio of luminances Lpb/Lib and of the ratio of luminances Lpd/Lib as a function of the RMS voltage of the applied disturbance signal Sp. In FIG. 5, the luminances Lpb and Lpd are both normalized with respect to Lib, the luminance of the initial passing state without an applied disturbance signal.

In this example, the effect of the disturbance signal Sp is triple.

Sp reduces the luminance Lpb of the passing state progressively as the value of Sp increases, to a value corresponding to the “equilibrium” state of the liquid crystal molecules under an applied field. Any increase in the applied voltage will virtually no longer modify the liquid crystal texture obtained. The effective value of the luminance corresponding to this state of equilibrium, called the “equilibrium” luminance Lo, is a function of the position of the polarizers of the cell.

Sp increases the luminance Lpd of the blocking state progressively as the value of Sp increases, to this same value called the “equilibrium” luminance Lo.

When this “equilibrium” Lo luminance is reached, one has Lpb=Lpd=Lo. The contrast between the passing state and the blocking state Lpb/Lpd is equal to 1:

Lpb/Lpd=1

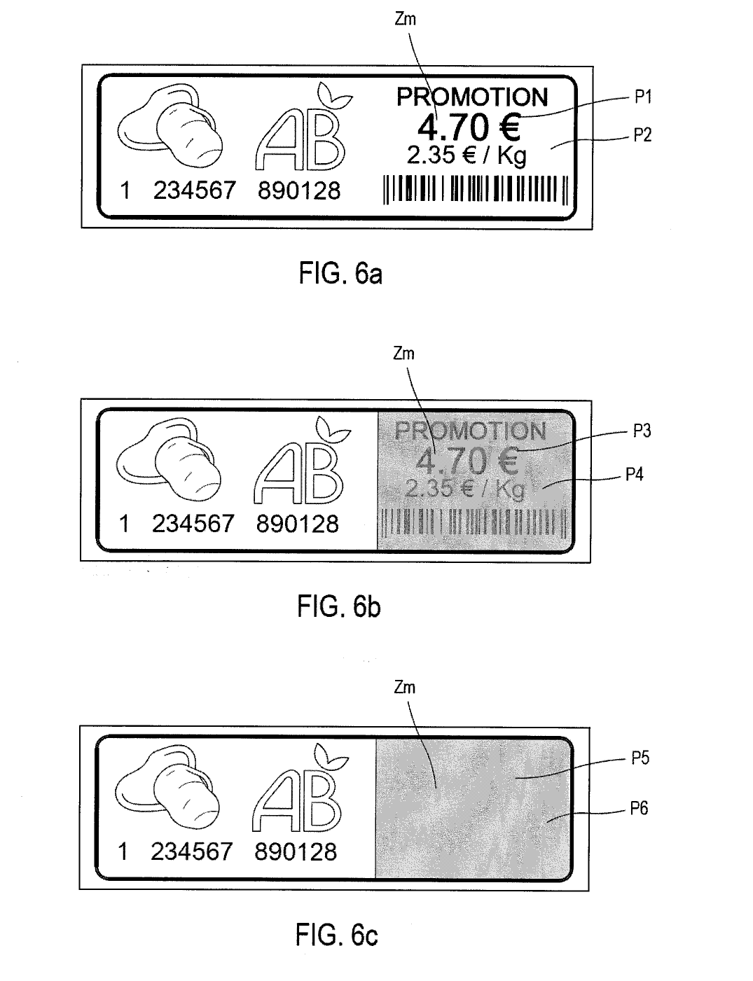

i.e. the image previously displayed is totally erased. A signal Sp such that the previously displayed image is erased is called the “erase” disturbance signal Sp. As illustrated in FIG. 6c, on applying an “erase” disturbance signal on a pixel P6 initially in a passing state and on a pixel P5 initially in a blocking state, the pixel P6 initially in the stable passing state is in the disturbed state identical to the disturbed state in which the pixel P5 initially in the blocking stable state is in, these disturbed states of pixels initially in two different stable states corresponding to a same visual perception for the observer observing the screen.

By way of non-limitative example, the result of the marking of an area Zm of the display corresponding to a joined set of columns of pixels (contiguous columns on the right of the display), called the marking area, is shown in FIGS. 6a, 6b and 6c. In these figures:

a pixel P1 in a stable blocking state is represented in black,

a pixel P2 in a stable passing state is represented in light grey, and

a pixel P3, P4, P5 and P6 in a disturbed state is represented in more or less dark grey.

FIG. 6a corresponds to the display in its initial state. The passing state corresponds here to the state T and the blocking state to the state U. FIG. 6b shows the image obtained with an “intermediate” disturbance signal Sp, i.e. with a reduction of the luminance of the passing state and an increase of the luminance of the blocking state, but without having reached the “equilibrium” luminance in the marking area. As illustrated in FIG. 6b, by applying an “intermediate” disturbance signal on a pixel P4 initially in a passing state and on a pixel P3 initially in a blocking state, the pixel P4 initially in the stable passing state is in a disturbed state different from the disturbed state in which pixel P3 initially in the stable blocking state is in, these disturbed states of pixels initially in two different stable states corresponding to different visual perceptions for the observer observing the screen. Thus, the passing state is darkened, the blocking state is distinctly less black also but the texture obtained from the starting textures U and T for this “intermediate” value of the disturbance signal are still optically distinct. All the pixels initially in the passing state are darkened in an identical fashion, and all the pixels initially in the blocking state are less black in an identical fashion. Although still visible, the image has a degraded contrast and the eye perceives the marking of this area perfectly. The disturbance signal modifies the visual perception of the marking area without any modification of the information contained in said area. FIG. 6c shows the image obtained with a signal Sp such that the “equilibrium” luminance is reached. For this value, the textures originating from U and from T appear optically identical, the previously displayed image is no longer visible, it is erased. Of course and a fortiori, the marking is perfectly perceptible. The disturbance signal Sp is therefore called the “erase” disturbance signal.

### Static Marking Mode or Blinking Marking Mode

The area Zm that one wishes to mark can be marked in two ways:
either with a disturbance of the image (step a) for the time t1) and an absence of disturbance signal (step b) for the time 2) such that the periodicity is less than a retinal persistence duration of the observer, in order to obtain a visual effect of static marking of the area, which will be called the static operating mode or the static marking mode, this mode being the most economical in terms of energy.
or with alternation of the disturbance of the area Zm for the time t1 and non-disturbance of the image for the time t2, at a frequency that is perceptible to the observer; this mode will be called the blinking mode or blinking marking; the time t1+t2 will then be for example longer than 0.1 second; thus, steps a) and b) are reiterated a number of times greater than 1, in order to obtain a visual effect of blinking of the area Zm caused by an alternation of the disturbed state and of the initial stable state for each pixel of the area.

### Frequency of the Disturbance Signal

During the time t1, the disturbance of the marking area can be obtained according to two variants:

either by applying a disturbance signal Sp constituted by a single continuous voltage of duration t1 and of amplitude Vblink lower than Vcass but higher than the threshold voltage V0 of the liquid crystal (zero frequency of the signal Sp); in this case, the disturbance signal Sp comprises an electric signal of constant voltage.
or by applying, in order to avoid a polarisation of the cell, despite the increase in energy consumption that this involves, a periodic disturbance signal Sp of non-zero frequency fp. For example, a train of pulses of sufficiently high frequency will give a homogeneous tint to the area during the disturbance (typically a frequency higher than 50 Hz, i.e. a period of the disturbance signal pp of less than 20 ms). If the frequency is lower than 50 Hz, the eye of the observer will be able to perceive fluctuations during the disturbance time t1.

Both of the modes are compatible with the sought effect, i.e. a disturbance of the image during the time or times t1 and then a return to the previously displayed image during the times t2 and after the marking.

For a period pp comprised between 20 ms and the response time of the liquid crystal (typically a few ms, i.e. a frequency fp between 50 Hz and 500 Hz), the liquid crystal will more or less follow the applied signal, and the eye will perceive an average luminance corresponding to the different orientations of the liquid crystal. The visual effect obtained, which will always be a difference in luminance in comparison with those of the stable states of the previously displayed image, will be a homogeneous tint depending on the shape of the signal applied during the period pp.

For a period pp less than the response time of the liquid crystal, typically a frequency fp higher than 500 Hz, the latter will be oriented according to the RMS (Root Mean Square) value of the periodic signal applied. The behaviour of the liquid crystal becomes independent of the shape of the applied signal and of its frequency: all that counts is the RMS value of the signal. In this case also, the disturbance will correspond to a homogeneous tint over time.

In all cases, the disturbance signal applied must have an RMS voltage lower than the breaking voltage Vcass and higher than the threshold voltage V0 of the liquid crystal.

### First Variant: Marked Area Equal to All of the Pixels of a Set of Rows or Columns

A first variant of the invention is to mark (in a static or blinking manner) an area Zm constituted by a set of q adjacent rows (respectively referenced

Lx1, Lx2, . . . Lxq) or a set of q adjacent columns (respectively referenced Cx1,Cx2, . . . Cxq), the marking involving all the pixels of the row or the column in question. Thus, the area Zm comprises a set of adjacent rows or a set of adjacent columns.

For example the static marking or blinking of a set of columns can be obtained by applying only a column signal on the columns of the blinking area, the rows being earthed or at a fixed potential.

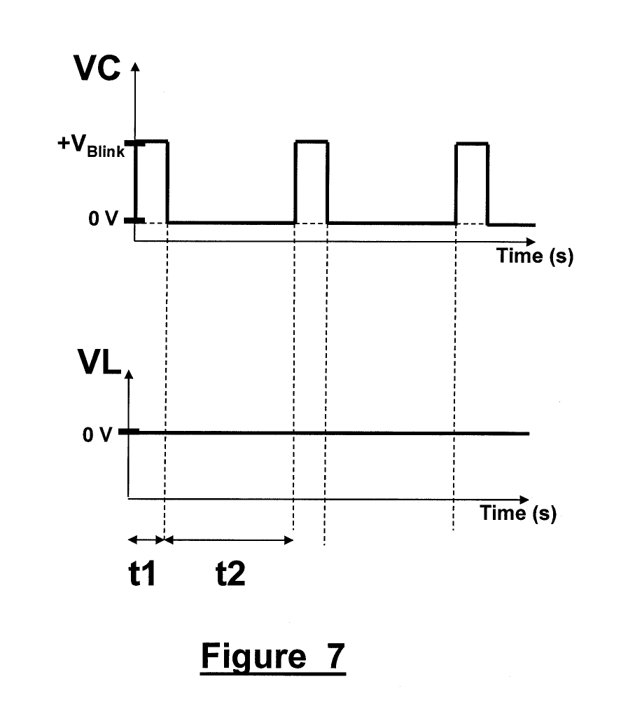

According to a first option it is possible to apply column signal VC, for example monopolar (positive or negative) having a pulse shape and amplitude Vblink, for example equal to 2.5 V for the duration t1 (the case of the continuous signal, for example t1=500 ms), as described in FIG. 7, simultaneously on a set of energized columns. The row signal VL is for example equal to 0V on all the rows, obtained for example by earthing all of the rows. The time t2 between two disturbances is for example equal to one second.

A variant (not illustrated in the figures) for avoiding storage of charges in the display is to apply a bipolar signal (+Vblink for half of t1 and then −Vblink for the other half of t1, or vice-versa). Another variant (not illustrated in the figures) is to apply +Vblink for t1 for one disturbance and to apply a signal −Vblink for t1 for the next disturbance.

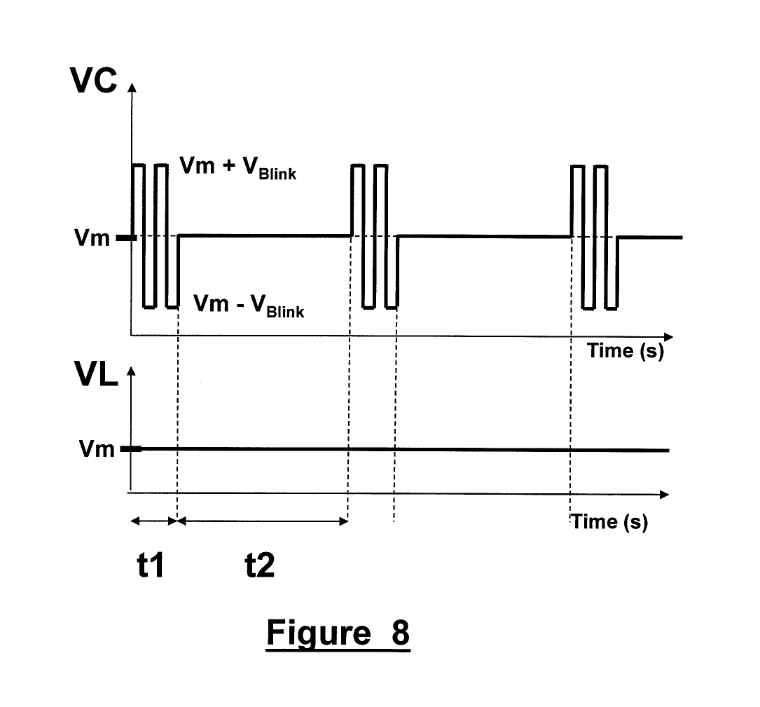

With reference to FIG. 8, a second option is to use a disturbance signal Sp of non-zero frequency fp, monopolar or bipolar. A bipolar disturbance signal Sp has the advantage of eliminating the drawbacks of a continuous electric polarisation which can cause storage of charges in the screen.

When the column drivers can deliver only a positive column signal , positive and negative alternations on the pixels of the columns can be obtained by setting the columns belonging to the static marking (or blinking marking) area at a mean potential Vm, the column signal being constituted by an alternation of Vm +Vblink and Vm−Vblink. The rows are set to the mean potential Vm, if necessary using an optimized and specific circuit for generating Vm. It is also necessary to apply Vm to the columns situated outside of the marking (or blinking) area, so that the latter do not undergo the optical disturbances caused by the application of Vm to the rows.

The variants allowing the blinking of a set of columns are of course applicable to a set of rows.

### Sensitivity of the Disturbance to the RMS Voltage

The disturbance signal Sp used in FIG. 6 is a monopolar column signal with a frequency of 600 Hz, the rows being earthed. As described previously, FIG. 6a corresponds to the display in its initial state. The passing state corresponds to the state T and the blocking state to the state U. FIG. 6b shows the image obtained with a disturbance signal Sp of RMS value 1.5V in the marking (or blinking) area. The textures obtained from the starting textures U and T for an RMS value of the applied signal of 1.5V are still optically distinct. This RMS voltage value therefore corresponds here to an “intermediate” disturbance signal Sp. Even though still visible, the image has a reduced luminance in the passing state, a degraded contrast and the eye perfectly perceives the marking of this area. The FIG. 6c shows the image obtained with a signal Sp of RMS value 2.5 V. For this value, the textures originating from U and T appear identical, almost all the molecules are raised by the applied field, the image is no longer visible. This value of RMS voltage therefore corresponds here to a “erase” disturbance signal Sp. Of course, and a fortiori, the marking is perfectly perceptible.

The disturbance signal Sp therefore preferably comprises an electric signal (VL−VC) having an effective RMS voltage value greater than 1.65 times the Freedericksz voltage VF of the layer of liquid crystal.

### Threshold Voltage

For a value of Sp less than or equal to what is called the threshold voltage V0 of the liquid crystal, the molecules of liquid crystal do not react to the applied field. Optically, this results in a luminance of the passing and dark states under a field equal to that without a field. This threshold voltage is a function of the liquid crystal, of the texture in which the latter is, of the frequency and of the factor of the shape of the applied signal. The threshold voltage is virtually identical for the two stable textures used here. The threshold voltage V0 is greater than or equal to the voltage VFs.

For the curve of FIG. 5, a liquid crystal such that VFs=0.6 V has been used, and it is noted that the luminances of the passing and blocking states remain constant approximately up to an RMS voltage, which therefore corresponds to the threshold voltage V0, close to VFs, i.e. 0.6 V.

### V5% Voltage

After numerous investigations, the inventors have shown that a marking was perceptible as soon as the luminance Lpb varied by least 5% with respect to its luminance Lib with no applied signal. When a part of the display (static or blinking marking area) is subjected to a disturbance signal Sp for a given time t1, V5% will refer to the value of the maximum voltage applied to a pixel initially in the passing state such that this voltage affects the luminance of the pixel in question by 5%. Above the frequency corresponding to the response time of the liquid crystal used, V5% is an RMS voltage. This V5% voltage is a function of the liquid crystal used, of the frequency of the applied signal Sp as well as of its shape factor, and of the time t1 for which the disturbance signal is applied; V5% is greater than or equal to VFs and to V0.

Thus, for each pixel of the area Zm initially in the passing state and to which a disturbance signal Sp is applied, the disturbed state of this pixel initially in the passing state has a luminance Lpb perceived by the observer as lower by at least 5%, or even 10% or even 20% with respect to the luminance Lib of the initial passing state of this pixel.

### Example of FIG. 5

In the example of FIG. 5, the signal Sp is a signal of frequency 600 Hz.

In an initial time, for values of Sp such that the RMS value is below the threshold voltage (here V0≈VFs=0.6V), no alteration of the displayed image is observed.

Then, starting from an RMS value of Sp greater than the threshold voltage V0, progressively as Sp increases, the molecules of liquid crystal rise, the optical consequence of which is a lowering of the luminance Lpb.

A drop of 5% of the luminance of the passing state (Lpd/Lib=0.95) corresponds to an applied voltage of approximately V5%=0.8V, i.e. to a voltage slightly higher than VFs.

For “intermediate” voltage values, a continuous lowering of the contrast (Lpb/Lpd) is observed, i.e. a reduction of Lpb conjointly with an increase in Lpd. For an applied RMS voltage value equal to 1.65 times VFs, i.e. 1V, the ratio Lpb/Lib=0.85. 0.85 is distinctly lower than 0.95, 0.95 corresponding to a drop of 5% of the initial luminance. In this example the reduction of luminance of the passing state is greater than 5% when the applied signal has an RMS value equal to 1.65 times VFs of the liquid crystal. Thus for a perceptible static or blinking marking, a value of Sp of 1.65 times VFs is sufficient. For a more marked static or blinking marking, the application of a signal having an RMS voltage equal to 2.5 times VFs will be chosen.

Starting from a certain critical value Vcri of the voltage of the disturbance signal, the disturbance signal Sp is an “erase” signal, and almost all the molecules are raised, the textures of the passing and dark states does not change any more and, optically, the luminances Lpb and Lpd of the disturbed states become equal to the equilibrium luminance Lo. This value of luminance Lo depends, among other things, on the angles of the polarizers used. In the experimental configuration described, this value is equal to 0.52 multiplied by Lib.

In this example, the minimum RMS voltage value in order to obtain the erasure of the previously displayed image is approximately 2V=3.3 times VFs. The marking of the area is in this case maximal.

Second Variant: Marking of the Intersection of N′ rows and M′ Columns of a Screen of N Rows and M Columns

A second variant of the invention is to mark (in a static or blinking manner) an area Zm comprising an intersection of a set of N′ adjacent rows and a set of M′ adjacent columns.

We have 1≦N′≦N and 1≦M′≦M. The rows or columns of which at least one pixel belongs to the area to be marked are called “energized”. Adjoining rows and columns, i.e. adjacent ones, are chosen in this case. It is of course possible to mark several areas of the display simultaneously, each area being at least equal to a pixel.

The signal applied to a pixel is the difference between the signal on its row and that on its column. The difficulty with respect to the preceding case is to optically disturb only the area situated at the intersection of the energized rows and columns, whilst the other pixels of the energized rows and columns not belonging to the area to be marked are not disturbed. This result is obtained by taking advantage of the existence of the threshold voltage of the display V0.

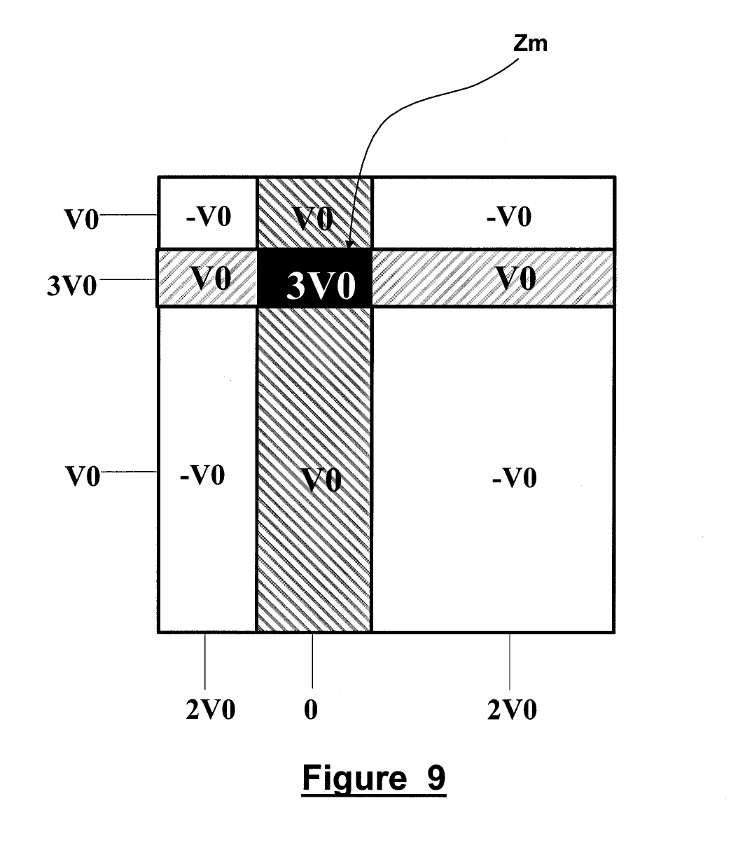

A first option is illustrated in FIG. 9. The marked area Zm is black, the band of energized rows is horizontal and is illustrated in light grey by hatching and the band of energized columns is vertical and is illustrated in dark grey by hatching. For the disturbance time t1, 3 times V0 RMS is applied to the energized rows and +V0 RMS is applied to the other rows, 0V RMS is applied to the energized columns and 2×V0 RMS is applied to the non-energized columns. Thus an RMS voltage V0 is applied to the whole of the screen except for the pixels of the area to be marked Zm which receive 3 times V0 RMS, which is broadly sufficient to obtain a disturbance of the previously displayed image. The pixels subjected to V0, the threshold voltage, will not react to this voltage and will remain stable.

V0 can also be applied to all of the rows, and V0 to the non-energized columns and −V0 to the energized columns.

No voltage is then applied to any row or column for the time t2. This mode allows a very visible disturbance , but it has the drawback of applying a potential difference over the whole of the display, which consumes approximately as much energy as does an image refresh. It should be noted however that in the case of a marking by blinking, the frequency of the blinking is approximately ten times lower than that of the refreshing of a conventional monostable display. Thus the power consumed by the invention is in this case ten times lower than that consumed by a conventional display.

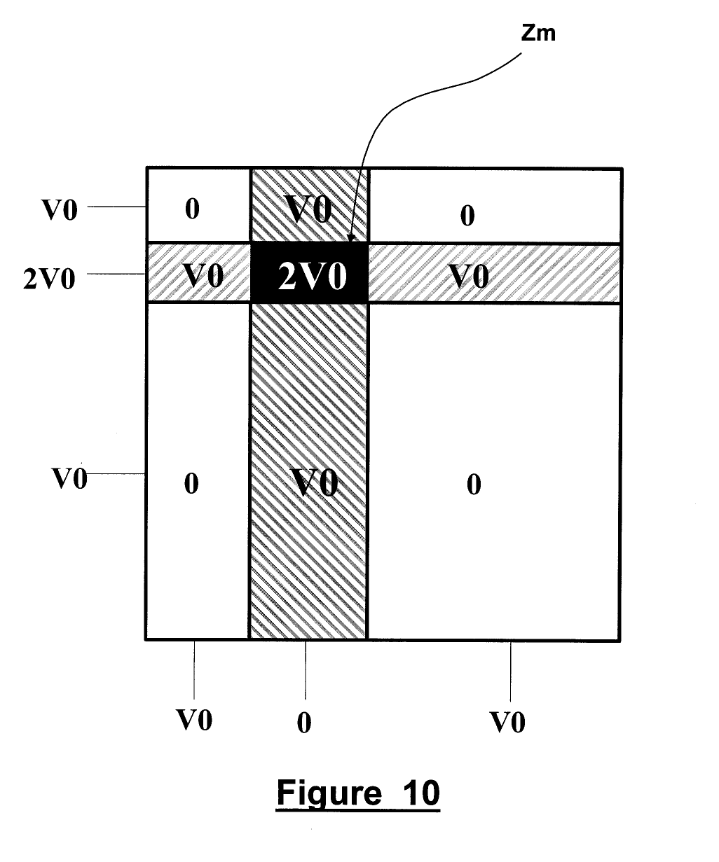

A second option is illustrated in FIG. 10. The marked area Zm is shown in black, the band of energized rows is horizontal and is shown in light grey, and the band of energized columns is vertical and shown in dark grey. This second option makes it possible to apply a potential difference only on the energized rows and columns, which consumes less energy. Two times V0 is applied to the energized rows and V0 to the other rows, 0V to the energized columns and V0 to the non-energized columns. Thus a zero voltage or V0 is applied to the pixels outside of the blinking area Zm, and two times V0 is applied to the pixels of the blinking area Zm. The disturbance signal is here two times V0 in comparison with three times V0 for the previous variant. The disturbance obtained for this second variant is less than that of the first variant if the case is that two times V0 does not make it possible to obtain the total erasure of the previously displayed image. However, a repeated dimming of the image, even without the disappearance of the latter, is sufficient to draw the eye which is sensitive to the temporal variation of luminance.

### Third Variant: Dynamic Cursor

A third variant of the invention is to mark (in a static or blinking manner) a mobile marking area Zm, called a “cursor”.

By applying the concepts described above, it is possible to position a dynamic cursor in a BiNem screen. The marking area Zm comprising the set of disturbed pixels is called a “cursor”. The set of pixels of the cursor Zm is disturbed such that it is differentiated from the remainder of the image displayed on the screen, this cursor Zm moving from one point to another of the screen in such a way as to recreate a “mouse” function of a computer. The method according to the invention then moreover comprises a displacement of the area of pixels Zm over the screen between at least two iterations of steps a) and b):

in a first variant, the method according to the invention comprises a displacement of the area of pixels Zm over the screen after each iteration of steps a) and b), or

in a second variant, the method according to the invention comprises a displacement of the area of pixels Zm over the screen after a number Q of iterations of steps a) and b) greater than 1, the area Zm being preferably marked in a blinking manner during the Q iterations during which Zm is immobile.

The rows and the columns addressed by the disturbance signal Sp will be different each time that the position of the “cursor” must change. The rapidity of displacement of the cursor will be adapted in order to obtain satisfactory following of the cursor by the eye of the observer. Of course, for this application only the pixels corresponding to the cursor will be addressed, the other pixels continuing to display the image because of the bistability of the screen.

For this application, the advantage of the invention is obvious. In fact, it suffices to mark the area of the cursor by moving it or by making it blink at least five times per second.

If the cursor is not in use, the bistable display according to the invention does not consume any electric power, whereas a screen with monostable liquid crystals according to the state of the prior art consumes a power P because it must refresh its image 50 times per second.

If the cursor is in use, a screen with monostable liquid crystals according to the state of the prior art still consumes the same power P, whereas the bistable display according to the invention must receive the same energy per pixel, but 5 times less often and only on the rows and the columns of the cursor. The power necessary for displaying a cursor of 5*5 mm² in a bistable screen having an A4 format is:

P bistable cursor=P conventional screen (N′/N+M′/M)*(5/50)≈P conventional screen/250

Thus, thanks to the proposed invention, it is possible to add a cursor to a bistable screen whilst increasing its consumption only marginally.

### DOCUMENTS CITED

Document [1]: “Grating Aligned Bistable Nematic Device”, G. P. Bryan-Brown et al , SID proceedings 1997, p 37-40
Document [2]: “Novel bistable liquid crystal displays based on grating alignment” J. Cliff Jones et al, SPIE proceedings vol, 3955 (2000), p 84-93
Document [3]: EP 0744 042
Document [4]: U.S. Pat. No. 6,327,017
Document [5]: I. Dozov et al, “Recent improvements of bistable nematic displays switched by anchoring breaking (BiNem)”, SID Proceedings 2001, p 224-227
Document [6]: P. Martinot Lagarde et al, SPIE vol. 5003 (2003), p 25-34
Document [7]: M. Giocondo, I. Lelidis, I. Dozov, G. Durand, Eur. Phys. LAPS, 227 (1999)
Document [8]: I. Dozov, Ph. Martinot-Lagarde, Phys. Rev. E., 58, 7442 (1998).
Document [9]: WO 2005/054 940
Document [10]: WO 2005/054 941
Document [11]: U.S. Pat No. 7,087,270
Document [12]: U.S. Pat. No. 7,067,180
Document [13]: U.S. Pat. No. 7,173,587
Document [14]: U.S. Ser. No. 10/536,419
Document [15]: U.S. Ser. No. 10/557,721
Document [16]: The Physics of Liquid Crystals (2nd Ed.), International Series of Monographs on Physics, 83, Clarendon, Oxford, 1974, DE GENNES P. G.-PROST J. p 123.
Document [17]: Thierry Leroux, SID 2002, Display Metrology 11-1
Document [18]: U.S. Pat. No. 6,795,146
Document [19]: U.S. Pat. No. 6,831,716
Document [20]: PCT/EP 2008/052 082

1. Method of addressing a matrix screen, said screen comprising:
a layer of bistable liquid crystal divided into pixels of bistable liquid crystal and,
for each pixel, means of applying a signal to this pixel, the applied signal comprising an electric field,
each pixel of bistable liquid crystal having two possible stable states which are stable without an electric field being applied to this pixel, the two stable states corresponding to different visual perceptions for an observer observing the screen, said method being characterized in that it comprising the following steps:
A. a signal called a disturbance signal is applied to each pixel of an area of pixels which are in an initial state corresponding to one of the stable states and for a given first period of time, said disturbance signal being higher than a threshold signal such that each pixel of the area leaves its initial state, said disturbance signal being lower than a switching signal such that each pixel of the area having one of the stable states as its initial state does not switch into the other stable state, each pixel of the area then being in a disturbed intermediate state between the two stable states, and then
B. no signal is applied to each pixel of the area for a second given period of time (t2) in order to allow each pixel to return to its initial stable state, and then
C. the preceding two steps A and B are reiterated.

2. Addressing method according to claim 1, wherein steps A and B are reiterated a number of times greater than 1, in order to obtain a visual effect of blinking of the area caused by an alternation of the disturbed state and of the initial state for each pixel of the area.

3. Addressing method according to claim 1, wherein steps A and B are iterated with a periodicity less than a duration of retinal persistence of the observer, in order to obtain a visual effect of static marking of the area.

4. Method according to claim 1 wherein it comprises a displacement of the area of pixels over the screen between at least two iterations of the steps A and B.

5. Method according to claim 1 wherein pixels are arranged in parallel rows of pixels and in parallel columns of pixels, the rows being substantially perpendicular to the columns.

6. Method according to claim 5, wherein the area comprises a set of adjacent rows or a set of adjacent columns.

7. Method according to claim 5, wherein the area comprises an intersection of a set of adjacent rows and a set of adjacent columns.

8. Method according to claim 5, wherein the disturbance signal applied to a pixel comprises a column signal applied to the column on which this pixel is situated and comprises moreover a row signal applied to the row on which is this pixel is situated and is proportional to a difference between the column signal and the row signal.

9. Method according to claim 1, wherein the disturbance signal is an erase signal for which the disturbed state of a pixel initially in one of the stable states is identical to the disturbed state of another pixel initially in the other stable state, the disturbed states of two pixels initially in two different stable states corresponding to a same visual perception for the observer observing the screen.

10. Method according to claim 1 wherein the disturbance signal is an intermediate disturbance signal for which the disturbed state of a pixel initially in one of the stable states is different from the disturbed state of another pixel initially in the other stable state, the disturbed states of two pixels initially in two different stable states corresponding to different visual perceptions for the observer observing the screen.

11. Method according to claim 1, wherein the disturbance signal comprises an electric signal of constant voltage.

12. Method according to claim 1, wherein disturbance signal comprises a periodic signal.

13. Method according to claim 12, wherein the frequency of the disturbance signal is between 50 Hz and 500 Hz.

14. Method according to claim 12, wherein the frequency of the disturbance signal is higher than 500 Hz.

15. Method according to claim 1, wherein the two stable states comprise a blocking state and a passing state, the passing state having a luminance perceived by the observer as higher than the luminance of the blocking state, the disturbed state of a pixel initially in the passing state having a luminance perceived by the observer as lower by at least 5% with respect to the luminance of the initial passing state of this pixel.

16. Method according to claim 1, wherein the disturbance signal comprises an electric signal having an effective RMS voltage value greater than 1.65 times a Freedericksz voltage of the layer of liquid crystal.

17. Method according to claim 1, wherein the disturbance signal is bipolar.
